(19) United States
(12) Patent Application Publication
(10) Pub. No.: US 2003/0215687 A1
(43) Pub. Date: Nov. 20, 2003

(54) Fuel cell system for a vehicle, in particular a motor vehicle

(76) Inventors: Rolf Bruck, Bergisch Gladbach (DE); Joachim Grosse, Erlangen (DE); Manfred Poppinger, Uttenreuth (DE); Meike Reizig, Bonn (DE)

Correspondence Address: LERNER AND GREENBERG, P.A., 2445 Hollywood Boulevard, Hollywood, FL, 33020, US

(21) Appl. No.: 10/426,520

(22) Filed: Apr. 30, 2003

Related U.S. Application Data
(63) Continuation of application No. PCT/DE01/04104, filed on Oct. 30, 2001.

(30) Foreign Application Priority Data
Oct. 30, 2000 (DE) 100 53 849.5

(51) Int. Cl. B60L 11/18; H01M 8/10; H01M 8/02

(52) U.S. Cl. 429/34; 180/65.3; 429/32

(57) ABSTRACT

A fuel cell unit for a vehicle, in particular a motor vehicle, has at least one fuel cell module and/or fuel cell stack. The fuel cell module is mechanically decoupled from the vehicle with damping elements and it is mounted between the floor and an underbody of the vehicle. The fuel cell module may advantageously be a flat stack with PEM fuel cells or HT-PEM cells.

### CROSS-REFERENCE TO RELATED APPLICATION

This application is a continuation of copending International Application No. PCT/DE01/04104, filed Oct. 30, 2001, which designated the United States and which was not published in English.

### BACKGROUND OF THE INVENTION

1. Field of the Invention

The invention relates to a fuel cell system for a vehicle, in particular to a fuel cell system and unit for a motor vehicle. The system has at least one fuel cell module and/or a fuel cell stack. Fuel cell stacks are also known in the pertinent art as stacks, for short.

Fuel cell systems are known for stationary as well as mobile applications. For example, European patent EP 0 677 412 B1 describes a system of this type specifically for use in a motor vehicle, in which the fuel cell module itself is arranged in a separate carrier structure in or below the vehicle floor. It is thereby an object to place all of the equipment of the fuel cell system, including the auxiliary equipment, that it is protected in the carrier structure but still accessible from the outside. Furthermore, U.S. Pat. No. 5,193,635 describes a fuel cell drive for a motor vehicle in which the fuel cell system is arranged in the vehicle protected beneath the vehicle seats. In this case, the individual system components, including the reformer, are to be arranged beneath the seats, elastically with respect to the vehicle floor.

In the prior art, arranging the fuel cell system in the carrier structure serves primarily to mechanically protect the fuel cell modules or the individual stacks in the event of sudden external influences, in particular accidents. However, in addition to this, the fuel cell stacks located in the vehicle are subject to a very wide range of effects from the vehicle during every day operation of motor vehicles equipped with fuel cell systems. The fuel cell stack is exposed to considerably fluctuating mechanical loads as a result of the actual driving operation itself, but also when the electric motor is idling. This causes problems in particular for fuel cell stacks comprising PEM fuel cells (PEM, proton exchange membrane or polymer electrolyte membrane). PEM fuel cells, in particular so-called HTM fuel cells (HTM, high temperature membrane) as a particular form of PEM fuel cells, are described in the commonly assigned German patent application DE 199 17 813 A.

2. Summary of the Invention

It is accordingly an object of the invention to provide a fuel cell system for a vehicle which overcomes the above-mentioned disadvantages of the heretofore-known devices and methods of this general type and which provides for suitable measures for reducing the mechanical loads on the fuel cell.

With the foregoing and other objects in view there is provided, in accordance with the invention, a fuel cell system for a vehicle having a vehicle body with a floor and an underbody. The fuel cell system comprises:

a fuel cell module having at least one fuel cell stack disposed in a space formed between the floor and the underbody of the vehicle; and

damping elements mounting the fuel cell module to the vehicle body in a mechanically decoupled manner.

In particular, the vehicle may be a motor vehicle with a motor and the fuel cell module is connected to drive the motor of the motor vehicle.

The invention proposes fitting the fuel cell stack and/or the fuel cell module to the vehicle in a position which is such that it is mechanically decoupled, in such a manner that the entire fuel cell system is at a suitable location beneath the vehicle floor. The fuel cell module is preferably configured as an planar stack which rests on an underbody or intermediate floor of the vehicle in a mechanically decoupled manner. Alternatively, the planar stack may also be suspended from the vehicle floor, which likewise results in mechanical decoupling with respect to the vehicle.

The mechanical decoupling is achieved with damping elements, such as springs, rubber buffers, rubber mounts, elastic mounts, spring mounts, and the like. The list is in no way exhaustive and it may include a number of additional such elements.

In accordance with an additional feature of the invention, the planar stack has a dimensional ratio of its long sides to its height of at least 3:1. Preferably, the ratio is between 5:1 and 20:1.

The fuel cell modules or fuel cell stacks are advantageously arranged at a suitable location of the vehicle body, in such a manner that no significant aerodynamic changes result. In particular, it is possible to avoid undesirable changes to the drag coefficient of the vehicle, yet when the vehicle is moving the air stream can still reach the planar stack.

The invention ensures, in a simple way, that external mechanical influences, in particular vibrations of the vehicle, are kept away from the sensitive fuel cell stacks. This is particularly favorable when using fuel cell modules which operate with PEM fuel cells or with HT-PEM fuel cells. In particular on account of the specific membranes required in the latter case, in this application there are particularly high demands with regard to long-term protection from fluctuating mechanical loads.

As has already been mentioned, the invention can be implemented in particular with fuel cell modules which are of flat design, i.e. so-called planar stacks with HT-PEM fuel cells. In this case, the three-dimensional form of the entire fuel cell system can be configured in such a way that only the planar stack with the HT-PEM fuel cell is arranged decoupled at a suitable location of the vehicle body, and that despite the planar stack and air stream feeds, the specific drag coefficient of the motor vehicle achieved by the vehicle design is substantially retained.

In accordance with a concomitant feature of the invention, the fuel cell installation contains HT-PEM fuel cells with membrane electrode assemblies (MEAS) with a self-dissociating and/or autoprotolytic electrolyte.

Other features which are considered as characteristic for the invention are set forth in the appended claims.

Although the invention is illustrated and described herein as embodied in a fuel cell system for a vehicle, in particular a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic side view of a fuel cell module positioned in a mechanically decoupled manner on the underbody of a vehicle;

FIG. 2 is a bottom plan view of a fuel cell module; and

FIG. 3 is a partial view illustrating an alternative configuration as compared to FIG. 1.

### DESCRIPTION OF THE PREFERRED EMBODIMENTS

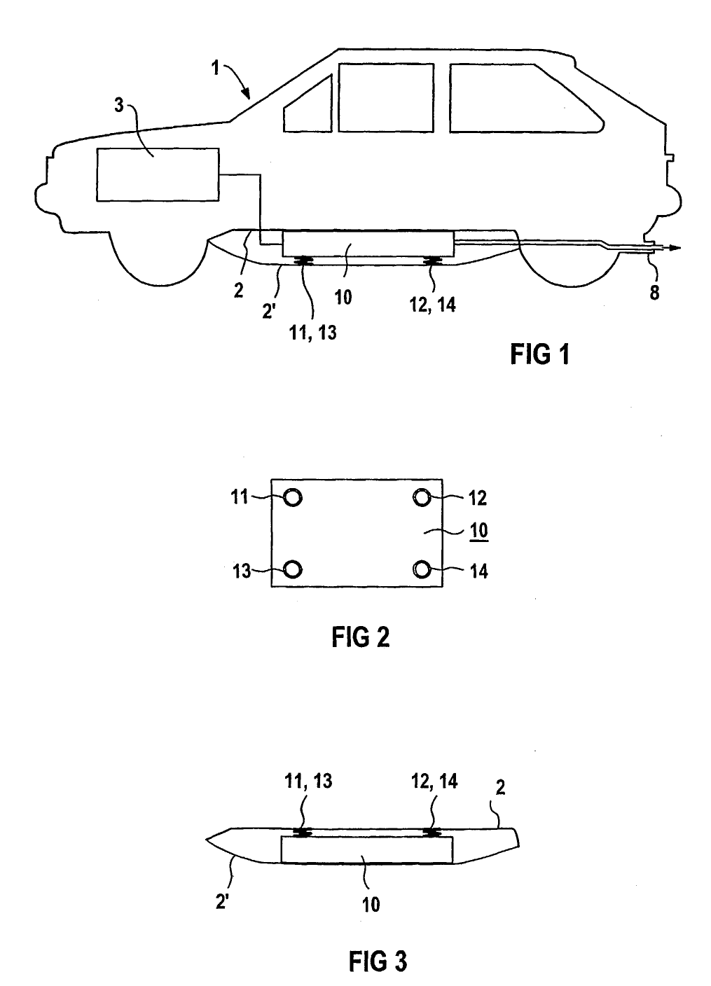

Referring now to the figures of the drawing in detail and first, particularly, to FIG. 1 thereof, there is shown a motor vehicle 1 which, by way of example, has an electric motor 3 as its drive and a fuel cell system 10 for providing the energy supply to the drive.

As noted above, it has already been proposed in the prior art for fuel cell modules to be arranged in or below the floor 2 of the motor vehicle 1 in a specific carrying structure. It is also possible (not prior art) for a further baseplate 2′ forming an underbody 2′ to be provided as a baseplate, so that the fuel cell system, or at least the sensitive fuel cell module 10, can be arranged in the space between the floor 2 and underbody 2′. A fuel cell module, which is only diagrammatically indicated here, is denoted by 10 in FIG. 1. It is electrically coupled to the drive 3. The motor vehicle 1 has an exhaust 8, to which a fluid line leads from the fuel cell module 10.

A fuel cell stack having a flat configuration is particularly suitable for the fuel cell module 10 for the indicated positioning in the space between the floor 2 and the underbody 2′. By way of example, flat fuel cell stacks of this type with dimensions in terms of the extent of the area edges with respect to the height of approximately 5:1 to approximately 20:1 are known. If the ratio is at least 3:1, it is possible to speak of a planar stack. The small structural height serves in particular to enable this part of the fuel cell system to be positioned in such a manner that it does not have any adverse effect on the drag coefficient of the vehicle. Nevertheless, when the vehicle is moving the air stream can reach the fuel cell module 10, suitable air feeds being provided for this purpose.

The latter may be important in particular, if, contrary to the illustration shown in the figure, the fuel cell system is arranged on the roof of a vehicle. This is advantageous, for example for truck or recreational vehicles, if a design of this type is proposed.

It can be seen from FIG. 1 in conjunction with FIG. 2 that the fuel cell module 10 is fitted to the underbody 2′ of the motor vehicle 1 by way of four damping elements 11 to 14 which are positioned at each corner of the planar stack. The individual damping elements 11 to 14 are advantageously arranged between the floor 2 and the planar stack 10, so that the planar stack resting there is damped. As a result, in many cases there is achieved sufficient mechanical decoupling of the entire fuel cell module 10 from the chassis of the motor vehicle 1.

This is made clearer in FIG. 2 by means of the view of the planar stack from below. An alternative to FIG. 1, with the planar stack suspended from the automobile floor 2, is shown in FIG. 3.

Suitable damping elements 11 to 14 are standard means from the prior art, such as in particular springs, but also rubber buffers or the like.

For use in practice, the damping elements 11 to 14 are individually matched to the resonant properties of the vehicle structure of the motor vehicle 1, on the one hand, and of the fuel cell system 10, on the other hand. The running properties of the motor vehicle 1, in particular including the idling properties of the motor 3, are also taken into account.

It is therefore possible by simple measures to effectively mechanically decouple the structural units, with the result that in particular an adverse effect of vibrations on the sensitive parts of the fuel cell stack, in particular the polymer membrane that forms the core piece of the fuel cell or—including the electrodes—the membrane electrode assembly (MEA) can be ruled out.

The latter is important whenever the fuel cell module includes PEM fuel cells. The term PEM fuel cells denotes fuel cells which operate with polymer electrolyte membranes according to the principle of proton exchange in the membrane (proton exchange membranes). The working temperature of the standard PEM fuel cells are, for example, 60° C., or in any event below 100° C., since in this case the water required for the water balance of the fuel cell evaporates at standard pressure.

So-called HT (high-temperature) PEM fuel cells, have meanwhile been proposed. Such fuel cells promise improved application properties. In particular HT-PEM fuel cells operate at temperatures between 60° and 300° C., in particular, at standard pressure, of between 120° C. and 200° C. On account of the specific MEAs required in this temperature range, which contain a self-dissociating and/or autoprotolytic electrolyte for proton conduction in the polymer membrane, however, they are particularly sensitive to any mechanical load. Even extremely slight vibrations can lead to undesirable long-term effects in the MEA.

Overall, when fuel cell modules with HT-PEM fuel cells are used in motor vehicles, the mechanical decoupling of the sensitive fuel cells or MEAs from the vehicle is particularly important.

We claim:

1. In a vehicle having a vehicle body with a floor and an underbody, a fuel cell system for the vehicle, comprising:
a fuel cell module having at least one fuel cell stack disposed in a space formed between the floor and the underbody of the vehicle; and
damping elements mounting said fuel cell module to the vehicle body in a mechanically decoupled manner.

2. The fuel cell system according to claim 1, wherein the vehicle is a motor vehicle with a motor and said fuel cell module is connected to drive the motor of the motor vehicle.

3. The fuel cell system according to claim 1, wherein the underbody of the vehicle is a baseplate underneath the vehicle, and said damping elements are disposed on said baseplate, with said fuel cell module resting on said damping elements.

4. The fuel cell system according to claim 1, wherein said damping elements are mounted to an underside of a vehicle floor, and said fuel cell module is suspended from said damping elements.

5. The fuel cell system according to claim 1, wherein said damping elements are selected from the group consisting of springs, rubber buffers, rubber mounts, elastic mounts, and spring mounts.

6. The fuel cell system according to claim 1, wherein said fuel cell stack is an planar stack.

7. The fuel cell system according to claim 6, wherein said planar stack has a ratio of long sides to a height of at least 3:1.

8. The fuel cell system according to claim 7, wherein the ratio is between 5:1 and 20:1.

9. The fuel cell system according to claim 1, wherein said fuel cell module with said fuel cell stack is disposed on the vehicle such that a drag coefficient of the vehicle is substantially not impaired.

10. The fuel cell system according to claim 1, wherein said fuel cell module includes PEM fuel cells.

11. The fuel cell system according to claim 1, wherein said fuel cell module includes HT-PEM fuel cells.

12. The fuel cell system according to claim 11, wherein said HT-PEM fuel cells include membrane electrode assemblies with a self-dissociating and autoprotolytic electrolyte.

13. The fuel cell system according to claim 11, wherein said HT-PEM fuel cells include membrane electrode assemblies with a self-dissociating electrolyte.

14. The fuel cell system according to claim 11, wherein said HT-PEM fuel cells include membrane electrode assemblies with an autoprotolytic electrolyte.
